(19) United States
(12) Patent Application Publication
(10) Pub. No.: US 2010/0147804 A1
(43) Pub. Date: Jun. 17, 2010

(54) PUFFER TYPE GAS CIRCUIT BREAKER

(75) Inventors: Naoto Yamada, Hitachi (JP); Makoto Hirose, Hitachi (JP); Tetsuo Ishiguro, Hitachi (JP)

Correspondence Address: BRUNDIDGE & STANGER, P.C., 2318 MILL ROAD, SUITE 1020, ALEXANDRIA, VA, 22314, US

(73) Assignee: JAPAN AE POWER SYSTEMS CORPORATION, Tokyo (JP)

(21) Appl. No.: 12/600,746

(22) PCT Filed: Jun. 2, 2008
(86) PCT No.: PCT/JP2008/060507

§ 371 Date: Nov. 18, 2009

(30) Foreign Application Priority Data
Jun. 25, 2007 (JP) 2007-165728

(51) Int. Cl. H01H 33/88

(52) U.S. Cl. 218/63

(57) ABSTRACT

An interrupting part 2 is arranged in a vessel 1 that is filled with insulating gas to configure a puffer type gas circuit breaker. The interrupting part 2 having, at least, a main contact 3, 6 on each of fixed- and moving-sides, an arcing contact 4, 7 on each of the fixed- and moving-sides, a puffing device, and an insulative nozzle 10. The insulating gas that became high temperature by being puffed into the arcs is discharged through a puffer shaft 11 of tubular shape. The puffer shaft 11 has a pipe member 11a at the distal end of which the arcing contact 7 is installed, and an end member 11b, one end of which is separably connected to the pipe member 11a with a joint 11 and the other end of which is connected to a rod 12 that links to a manipulator side.

### TECHNICAL FIELD

The present invention relates to a puffer type gas circuit breaker to be used for the open-close operation of circuits in power transmission and distribution lines and particularly relates to a puffer type gas circuit breaker that interrupts current by puffing arc-extinguish insulating gas into the arcs which are produced when current is interrupted.

### BACKGROUND ART

In general as shown in FIG. 3, a puffer type gas circuit breaker has a metallic vessel 1, in which an interrupting part 2 comprising a fixed-contact section and a moving-contact section, which are supported by insulant 14 and 15, is arranged; further, the inside of the vessel 1 is filled with an arc-extinguish gas such as sulfur hexafluoride (SF₆) having a good performance in insulating and arc-extinguish properties. Spurs at the both ends of the vessel 1 are provided with current-conveying conductors 16 and 17, through which the interrupting part 2 is connected to a power transmission and transformation system.

The fixed-contact section of the interrupting part 2 comprises a main contact 3 on the fixed-side, an arcing contact 4 on the fixed-side, a fixed-side conductor 5 that is electrically conductive with them, and the insulant 14 that supports the fixed-side conductor 5 on the vessel 1. The moving-contact section of the interrupting part 2 comprises a moving main contact 6 that is connected to the current-conveying conductor 17 through a moving-side conductor 8; an arcing contact 7 on the moving-side, which contacts to and separates from the arcing contact 4 on the fixed-side; a puffer cylinder 9a and a piston 9b that form a puffing device which works on circuit-breaking to compress the insulating gas; an insulative nozzle 10 that puffs the compressed insulating gas into the arcs at the arcing contacts 4 and 7; the main contact 6 on the moving-side, which contacts to and separates form the main contact 3 on the fixed-side; a puffer shaft 11 of tubular shape, at the distal end of which the arcing contact 7 on the moving-side is installed; a rod 12, one end of which is connected to the puffer shaft 11 and the other end of which is connected to a manipulator side (manipulator not shown in the figure) using a connecting member 13 such as a pin; and the insulant 15, etc that supports the moving-side conductor 8 on the vessel 1.

The puffer shaft 11 is arranged in the center of the moving-side conductor 8 and the puffing device comprising a puffer piston 9b and the puffer cylinder 9a so that the puffer shaft 11 can move linearly inside thereof together with the rod 12 that is connected to the manipulator.

In the puffer type gas circuit breaker of this kind, the insulating gas is compressed by the puffing device to be puffed into the arcs between the arcing contacts 4 and 7 on the current interruption by the interrupting part 2 for extinction. The arc-extinguish insulating gas that became high temperature by being puffed into the arc between the arcing contacts 4 and 7 is discharged from a discharging hole 11c passing through inside the puffer shaft 11 of tubular shape. Because of this, the puffer shaft 11 has usually used a one-body-formed member of metal having high melting point.

A puffer type gas circuit breaker has been proposed in Publication of JP05-20987A (Patent Literature 1), wherein the puffer shaft 11 is formed in a double-layered structure comprising an outer pipe of metal such as aluminum and an inner insulative pipe of an insulant such as polytetrafluoroethylene (PTFE) so that, on circuit breaking, the movements of the moving main contact 6, the arcing contact 7 on the moving-side, and the puffing device can be performed at a higher speed.

However, when the puffer shaft 11 is formed in the one-body style as mentioned above, a damage on the puffer shaft 11 caused from a long-time use requires replacement of the entirety thereof even if the damage is partial, which is uneconomical; further with such style of construction, it is difficult to satisfy both the speed-up of the circuit-breaking movement and the enhancing of the mechanical strength.

More concretely, the puffer shaft 11 becomes heavy when formed in the one-body style using a high-strength member, steel for example, although the insulating gas that has become high temperature affects less the puffer shaft 11. Therefore, a high-speed movement of the puffing device and other relevant elements requires a large manipulation force with the speed-up of the circuit-breaking movements inhibited. In contrast, the puffer shaft 11 becomes light when formed in the one-body style using a light specific gravity member, aluminum for example, enabling the circuit-breaking movements to speed up. This however has involved a fear of deformation or breakage of the puffer shaft 11 because the mechanical strength of such a portion thereof as connects to the rod 12 becomes less strong than the one in the steel.

Further, when the puffer shaft 11 is formed in one-body style using aluminum of a low melting point material, the end portion which has the discharging hole 11c, is heavily affected by the high temperature gas on current interruption. The discharging hole 11c of such construction discharges high temperature gas, which is passing through inside the puffer shaft 11, into the inside of the moving-side conductor 8; this causes the discharged high temperature gas to permeate the inside of the moving-side conductor 8 for a certain length of time. Because of this, there has been a problem that both the inside and the outside of the end portion of the puffer shaft 11 are exposed to a high temperature to suffer deterioration by the heat of the high temperature.

An object of the present invention is to provide a puffer type gas circuit breaker that, by changing the construction of the tubular shaped puffer shaft that discharges the insulating gas puffed into the arc therethrough, is eased and economized in puffer shaft replacement, and increased in speed of circuit-breaking with enhanced mechanical strength.

### DISCLOSURE OF INVENTION

A puffer type gas circuit breaker according to the present invention has an interrupting part arranged in a vessel that is filled with insulating gas, the interrupting part comprising, at least, a main contact on each of fixed- and moving-sides, an arcing contact on each of the fixed- and the moving-sides, a puffing device that compresses the insulating gas, and an insulative nozzle that puffs the insulating gas into the arcs between each of the arcing contacts, the insulating gas, which have been puffed into the arcs, being discharged through a puffer shaft of tubular shape, wherein the puffer shaft comprises a pipe member at the distal end of which the arcing contact on the moving-side is installed, and an end member, one end of which is separably connected to the pipe member and the other end of which is connected to a rod that links to a manipulator side.

Preferably, the pipe member is formed from a material having a specific gravity smaller than that of the end member, the end member being formed from a material having high mechanical strength and a melting point higher than that of the pipe member. Further, the pipe member is formed from aluminum, and the end member is formed from steel.

A puffer type gas circuit breaker according to the present invention has an interrupting part is arranged in a vessel that is filled with insulating gas, the interrupting part comprising, at least, a main contact on each of fixed- and moving-sides, an arcing contact on each of the fixed- and the moving-sides, a puffing device that compresses the insulating gas, and an insulative nozzle that puffs the insulating gas into the arcs between each of the arcing contacts, the insulating gas, which have been puffed into the arcs, being discharged through a puffer shaft of tubular shape, wherein the puffer shaft comprises a pipe member made of aluminum at the distal end of which the arcing contact on the moving-side is installed, and an end member made of structural carbon steel, one end of which is separably connected to the pipe member and the other end of which is connected to a rod that links to a manipulator side.

### EFFECT OF INVENTION

Configuring a puffer type gas circuit breaker as defined by the present invention enables economized manufacturing because replacing only the pipe member or the end member in the damaged portion is enough even if the puffer shaft is damaged by a long-time use. Moreover, it becomes practicable to effectively apply materials in varieties of properties severally to the pipe member and the end member.

Additionally, using a material of small specific gravity for the pipe member of the puffer shaft and using a material of high mechanical strength and of higher melting point than the material of the pipe member for the end member enhance the mechanical strength, without disturbing speeding up the circuit-breaking movement, and prevent the puffer shaft from deformation and thermal deterioration by the heat of the high temperature gas.

Still additionally, a combined use of the pipe member of aluminum and the end member of structural carbon steel in forming the puffer shaft enables a long-term use offering further-increased economy since such combined use permits enhancing also mechanical strength and speeds the circuit-breaking movement.

### BRIEF DESCRIPTION OF DRAWINGS

FIG. 1 is a schematic vertical sectional view of an embodiment of the puffer type gas circuit breaker according to the present invention.

FIG. 2 is an enlarged schematic vertical sectional view of part A in FIG. 1.

FIG. 3 is a schematic vertical sectional view of a conventional puffer type gas circuit breaker.

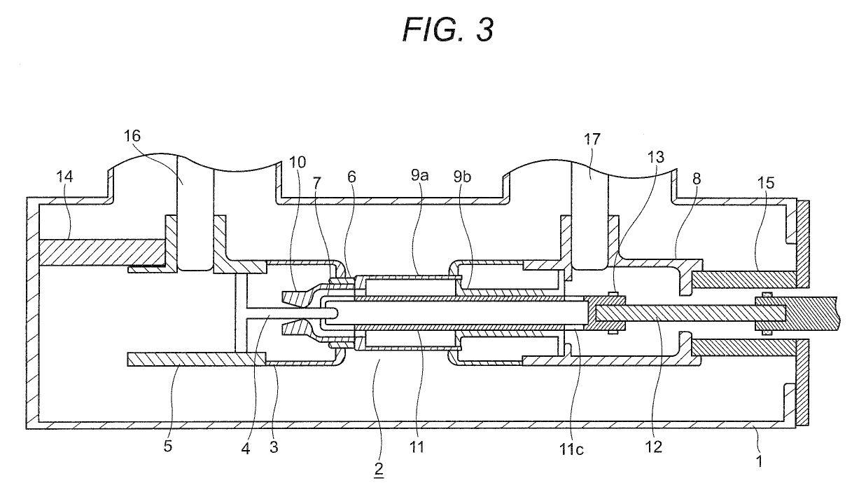

### BEST MODE FOR CARRYING OUT THE INVENTION

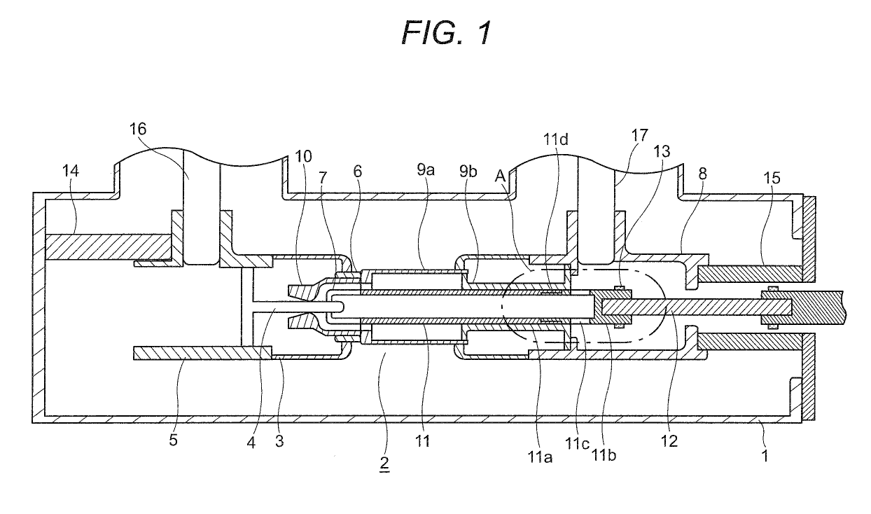

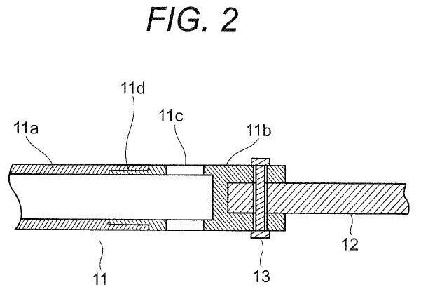

The following explains a puffer type gas circuit breaker of the present invention referring to an embodiment shown in FIG. 1 and FIG. 2, wherein constituting portions that are same as those in the conventional circuit breakers are given the same signs as ones in the conventional items.

The puffer type circuit breaker comprises, like the conventional circuit breaker, an interrupting part 2, which connects to current-conveying conductors 16 and 17, arranged inside a vessel 1 inside of which is filled with insulating gas. The interrupting part 2 that is operated by a manipulator (not shown in the figures) has the same structure as the conventional structure in terms of a fixed-contact section and a moving-contact section.

At the time when the condition is brought to the state of the circuit-breaking movement from the state in which each of the contacts is being closed, as shown in FIG. 1, by the operation of the manipulator, the main contact 6 on the moving-side, an arcing contact 7 on the moving-side, a puffer cylinder 9a, and an insulative nozzle 10 are configured so that they will move rightward in the figure. In the midst of the contact-opening movement of the interrupting part 2, the insulating gas compressed by a puffing device comprising the cylinder 9a and a puffer piston 9b is puffed from the insulative nozzle 10 into the arcs between the arcing contacts 4 and 7 for extinction.

The insulating gas that has become high temperature after being puffed into the arc is discharged inside a moving-side conductor 8 of a hollow shape from a discharging hole 11c passing through the hollow of a puffer shaft 11 by the present invention, which penetrates the center of the puffer piston 9b, to be finally discharged inside the vessel 1.

The puffer shaft 11, as shown in FIG. 1 and FIG. 2, has a separably integrated structure composed of two members of a pipe member 11a and an end member 11b, each having almost same diameter. As will be mentioned later, the pipe member 11a is manufactured, using material of small specific gravity, in a hollow shape to permit the high temperature gas to pass therethrough, and is provided with the arcing contact 7 at the distal end thereof. As will be mentioned later, the end member 11b is manufactured using material of high mechanical strength and of melting point higher than the material of the pipe member 11a. One end of the end member 11b is integrally but separably connected to the pipe member 11a at a joint 11d and the other end thereof is connected to the rod 12, which is linked with the manipulator side, with a connecting member 13 such as a linking pin.

In this example, the discharging hole 11c that discharges the insulating gas is provided on the end member 11b. However, the discharging hole 11c may be provided either on the pipe member 11a or on the end member 11b. When the pipe member 11a is given, for example, such a length as extends inside the moving-side conductor 8 to be provided with the discharging hole 11c thereon, the shape of the end member 11b side can be formed in a solid body only having the jointing portion.

The joint 11d, which connects the pipe member 11a and the end member 11b, is made to form a screwing-in joint rendered by threads provided on both the pipe member 11a and the end member 11b, as shown in FIG. 1 and FIG. 2 for example, so that the discharging of the insulating gas will not be impeded. Thereby, the joint 11d between them can provide a structure having such a performance that the connection will be maintained without occurrence of disconnection even if a rapid motion in the circuit-breaking movement or the high temperature insulating gas (a hot gas) affects the jointed portion, offering moreover an eased connection-disconnection.

The pipe member 11a is manufactured with material having a small specific gravity, like aluminum or fiber reinforced plastics for example, and having mechanical strength and a specific gravity smaller than that of the material of the end member 11b, preferably not larger than four. The reason for using material of small specific gravity like aluminum in manufacturing the pipe member 11a is to reduce the overall weight of the puffer shaft 11 for enabling a higher-speed motion with a smaller driving force.

When aluminum is used for the pipe member 11a, the thermal deterioration that can be incurred by the high temperature insulating gas that passes inside the pipe member 11a on the current interruption would not be a serious problem. More concrete explanation follows: The puffing device is provided outside the pipe member 11a and the insulating gas is puffed toward the insulative nozzle 10. This configuration makes the high temperature insulating gas hardly enter the puffing device section with the puffing device section being in a low temperature state. Therefore, although the high temperature insulating gas passes inside the pipe member 11a, the heat thereby dissipates to the outside, of which temperature is relatively low, with the influence of the thermal deterioration reduced to a very little degree.

The end member 11b is manufactured with material having mechanical strength and a melting point higher than a melting point of the material of the pipe member 11a, such as steel like structural carbon steel or stainless steel for example, and a specific gravity larger than that of the material of the pipe member 11a, preferably larger than four. The reason for using material having strong mechanical strength, a high melting point, and a large specific gravity in manufacturing the end member 11b is to prevent deformation of the puffer shaft 11 enduring a large stress that appears at the connecting portion with the rod 12 when the movement of the puffer shaft 11 is made to work at a higher speed to enable an instant interruption of a large current at the interrupting part 2 on system failure. The reason further includes the prevention of the thermal deterioration of such a portion as is exposed to the insulating gas when the high temperature insulating gas is discharged through the discharging hole 11c inside the moving-side conductor 8, to provide a structure that has excellent thermal resistivity.

The puffer shaft 11 is formed usually in a minimal-required size to reduce the inertia mass. It is therefore not practical to increase the diameter of the connecting member 13 unnecessarily larger that connects the end member 11b and the rod 12; the connecting member 13 is manufactured considering the tensile stress in the rod 12. The driving force on the circuit-breaking manipulation impresses a large pressure onto the contact face between the end member 11b and the connecting member 13. Therefore, using material having strong mechanical strength and a melting point higher than that of the material of the pipe member 11a, steel for example, in manufacturing the end member 11b that composes the puffer shaft 11, eliminates occurrence of a play or breakage at the joint 11d between the end member 11b and the rod 12 since such material provides a mechanical strength that endures high stress compared to those materials having small specific gravity like aluminum.

The puffer shaft 11 thus configured attains lightening in the overall weight permitting a high-speed manipulation in the circuit-breaking movement with a small driving force. The pipe member 11e and the end member 11b are separable each from the other at the joint 11d. When the high temperature insulating gas has caused thermal damage either of on the pipe member 11a or on the end member lib or when the driving motion of the rod 12 has caused a deformation at the joint on the end member 11b, replacing only such damaged or deformed portion is enough for remedy with the maintenance cost reduced.

The puffer shaft 11 is separable. Therefore, components not only having same properties but also having different properties in such as melting points, specific gravities, or mechanical strengths can be used in the pipe member 11a and the end member 11b with increased freedom in the material combination leading to an eased manufacturing. In particular, using aluminum for the pipe member 11a and iron for the end member 11b satisfies the requirements of the puffer shaft 11 for both the speed-up of the circuit-breaking movement and the increase in the mechanical strength.

### INDUSTRIAL APPLICABILITY

In the puffer type gas circuit breaker according to the present invention, the puffer shaft comprises the pipe member, at the distal end of which the arcing contact on the moving-side is installed, and the end member, one end of which is separably connected to the pipe member and the other end of which is connected to the rod that is links to the manipulator side. This configuration is easily applicable and replacing only the pipe member or the end member in the damaged portion is enough even if the puffer shaft is damaged by a long-time use.

1. A puffer type gas circuit breaker having an interrupting part arranged in a vessel that is filled with insulating gas, the interrupting part comprising, at least, a main contact on each of fixed- and moving-sides, an arcing contact on each of the fixed- and the moving-sides, a puffing device that compresses the insulating gas, and an insulative nozzle that puffs the insulating gas into the arcs between each of the arcing contacts, the insulating gas, which have been puffed into the arcs, being discharged through a puffer shaft of tubular shape, wherein the puffer shaft comprises a pipe member at the distal end of which the arcing contact on the moving-side is installed, and an end member, one end of which is separably connected to the pipe member and the other end of which is connected to a rod that links to a manipulator side.

2. The puffer type gas circuit breaker according to claim 1, wherein the pipe member is formed from a material having a specific gravity smaller than that of the end member, the end member being formed from a material having high mechanical strength and a melting point higher than that of the pipe member.

3. The puffer type gas circuit breaker according to claim 2, wherein the pipe member is formed from aluminum, and the end member is formed from steel.

4. A puffer type gas circuit breaker having an interrupting part arranged in a vessel that is filled with insulating gas, the interrupting part comprising, at least, a main contact on each of fixed- and moving-sides, an arcing contact on each of the fixed- and the moving-sides, a puffing device that compresses the insulating gas, and an insulative nozzle that puffs the insulating gas into the arcs between each of the arcing contacts, the insulating gas, which have been puffed into the arcs, being discharged through a puffer shaft of tubular shape, wherein the puffer shaft comprises a pipe member made of aluminum at the distal end of which the arcing contact on the moving-side is installed, and an end member made of structural carbon steel, one end of which is separably connected to the pipe member and the other end of which is connected to a rod that links to a manipulator side.
